(19) United States
(12) Patent Application Publication
(10) Pub. No.: US 2012/0094189 A1
(43) Pub. Date: Apr. 19, 2012

(54) LITHIUM-SULFUR BATTERY

(75) Inventors: Bruno Scrosati, Roma (IT); Jusef Hassoun, Latina (IT)

(73) Assignee: IUCF-HYU (Industry-University Cooperation Foundation Hanyang Univeristy), Seoul (KR)

(21) Appl. No.: 13/263,346

(22) PCT Filed: Apr. 8, 2010
(86) PCT No.: PCT/KR10/02161

§ 371 Date: Jan. 4, 2012

(30) Foreign Application Priority Data
Apr. 8, 2009 (IT) RM2009A000161

(51) Int. Cl. H01M 10/056; H01M 4/40; H01M 4/46; H01M 4/38

(52) U.S. Cl. 429/314

(57) ABSTRACT

Disclosed is a lithium-sulfur polymer battery having a anode and a cathode separated by an electrolyte formed by a membrane containing a solution of a lithium salt in aprotic organic solvents with the addition of lithium sulfide and/or lithium polysulfides until saturation, this solution being trapped in a polymer matrix.

### TECHNICAL FIELD

The present invention relates to the field of lithium-ion batteries, in particular to lithium-sulfur polymer batteries with new electrochemical configurations and with high specific energy, cathode stability, and long operating life.

### BACKGROUND ART

Presently marketed lithium or lithium-ion batteries, in their classical configuration, are made of a graphite anode (negative electrode), a lithium metal oxide based cathode (positive electrode), in particular lithium cobalt oxide, LiCoO₂, which are separated by an electrolyte formed by a solution of a lithium salt, in particular lithium hexafluoro phosphate (LiPF₆), in a mixture of organic solvents, in particular ethylene carbonate and dimethyl carbonate (EC-DMC). This liquid solution is adsorbed on a separator felt. To date, these batteries prevail on the mobile electronic market.

Lithium batteries are potentially also fit for emerging markets, bound to urgent problems of our society, such as renewable energy, by potentiating power stations with clean sources (solar and/or wind) and cutting air pollution, by putting on the road large fleets of sustainable vehicles, such as hybrid and/or electric cars. Present lithium battery technology does not yet allow their penetration on these markets: for this purpose it is necessary to increase energetic content, decrease the cost and implement safety level. This goal can be reached only by modifying the nature of the electrolytic system, with the development of electrode and electrolytic materials more energetic and cheaper than the present ones.

An electrochemical system which can lead to this condition is the one consisting of the combination of a lithium (or lithium-ion) anode and a sulfur-based cathode that can reach a specific capacity equal to 1670 mAh/g, which is one order of magnitude higher than the one of the present LiCoO₂. The use of sulfur, instead of LiCoO₂, can thus bring to significant increase of energy; moreover, sulfur is much more abundant than cobalt, giving thus the basis of much lower costs. Electrochemical process of the lithium-sulfur battery in its most classical version comprises the formation of lithium sulfide during discharge: 2Li+S Li₂S and its reconversion into lithium and sulfur during charge: Li₂S 2Li+S.

### DISCLOSURE OF INVENTION

### Technical Problem

It has been found that particular electrodic and electrolytic configurations of lithium-sulfur and lithium ion-sulfur battery solve the problems of the state of the art by providing electrochemical systems with performances higher than the conventional ones.

### Solution to Problem

According to one embodiment, a iithium-sulfur polymer battery is provided that includes a negative electrode and a positive electrode separated by an electrolyte medium. The electrolyte medium is formed by a membrane containing a solution of a lithium salt in aprotic organic solvents with the addition of lithium sulfide and/or lithium polysulfides until saturation, this solution being trapped in a polymeric matrix.

The electrolyte medium is a membrane formed by hot pressing a mixture of polymer powders and a lithium salt.

The polymer powders are selected from the group consisting of poly(ethylenoxide)(PEO), poly(acrylonitrile)(PAN), poly(vinylidene fluoride), (PVdF).

The lithium salt is selected from the group consisting of LiCF₃SO₃, LiPF₆, LiClO₄, LiBF₄, LiB(C₂O₄), LiN(SO₂F)₂, LiN(SO₂CF₃)₂, LiN(SO₂C₂F₃)₂.

The solution is formed by a mixture of aprotic organic solvents, selected from the group consisting of ethylene carbonate (EC), propylene carbonate (PC), dimethyl-carbonate (DMC), ethyl methyl carbonate (EMC), diethyl carbonate (DEC).

The negative electrode (anode) is a lithium metal foil or a composite of the M-C type where M is selected from the group consisting of Sn, Si, Sb, Mg, Al and/or by a combination among them. The M-C composite is cast as a thin film on a substrate formed by copper.

The positive electrode (cathode) is based on lithium sulfide, Li₂S, and formed by a mixture of lithium sulfide and carbon, Li₂S—C. The composite Li₂S—C is cast as a thin film on a substrate formed by aluminum.

### Advantageous Effects of Invention

The lithium-sulfur battery has improved high specific energy, cathode stability, long operating life and the like.

### BRIEF DESCRIPTION OF DRAWINGS

The above and other aspects and features of the general inventive concept will become more readily apparent by describing in further detail exemplary embodiments thereof with reference to the accompanying drawings.

FIG. 1 shows a charge and discharge cycle run at t=60° C. and at a rate of C/20 (evolution of the capacity in mAh/g) for the lithium-sulfur polymer battery made by an anode of lithium metal, a cathode based on Li₂S—C and a polymeric electrolytic membrane of PEO-LiCF₃SO₃-EC:DMC, LiPF₆, LiₓS_{y} sat.

FIG. 2 shows repeated charge and discharge cycles run at t=60° C. and at a rate of C/20 (evolution of the capacity in mAh/g) and in subsequent times for the lithium-sulfur polymer battery made by a lithium metal anode, a cathode based on Li₂S—C and a PEO-LiCF₃SO₃-EC:DMC, LiPF₆, LiₓS_{y} sat. electrolytic polymeric membrane.

FIG. 3 shows the response in repeated charge and discharge cycles run at t=60° C. and at a rate of C/20 (evolution of the capacity in mAh/g) for the lithium-sulfur polymer battery made by a lithium metal anode, a cathode based on Li₂S—C and a PEO-LiCF₃SO₃-EC:DMC, LiPF₆, LiₓS_{y} sat. electrolytic polymeric membrane.

FIG. 4 shows the cycles of charge at a rate of C/5 and discharge at a rate of C/20 run at t=60° C. (evolution of the capacity in mAh/g) for the lithium ion-sulfur polymer battery made by an anode based on Sn—C, a cathode based on Li₂S—C and an electrolytic polymeric membrane PEO-LiCF₃SO₃-EC:DMC, LiPF₆, LiₓS_{y} sat.

### BEST MODE FOR CARRYING OUT THE INVENTION

The general inventive concept now will be described more fully hereinafter with reference to the accompanying drawings, in which various exemplary embodiments are shown. This invention may, however, be embodied in many different forms, and should not be construed as limited to the embodiments set forth herein. Rather, these exemplary embodiments are provided so that this disclosure will be thorough and complete, and will fully convey the scope of the invention to those skilled in the art.

The concept of the Li—S battery is not new. There are a number of publications describing its features and potentialities. However, up to now, their technological development is impeded by solubility of polysulfides, LiₓS, the electrochemical reaction products, which dissolves in the commonly used electrolyte medium, so to say the organic liquid solutions.

Advantageously, the present invention solves the problem with the use of a new electrolyte medium made by a membrane prepared by immobilizing a solution of a lithium salt (e.g. preferably but not exclusively LiPF₆, LiClO₄, LiCF₆SO₃, LiBOB, LiTFSI) in a organic solvent mixture (e.g. preferably but not exclusively EC-DMC, EC-DEC, EC-PC, EC-PC-DMC, EC-PC-DEC, EC-DEC-DMC) added with lithium sulfides (Li₂S) and/or polysulfides (LiₓS) till saturation, in a polymeric matrix (e.g. preferably but not exclusively polyethylene oxide (PEO), polyvinyldene fluoride (PVdF), polyethylene glycol (PEG) or a combination thereof) containing a lithium salt (e.g. preferably but not exclusively LiCF₆SO₃, LiPF₆, LiClO₄, LiBOB, LiTFSI, or a combination thereof). This electrolytic polymeric medium will be subsequently indicated with the shortened annotation PSG (Polimeric Sulfide saturated Gel).

The advantages of this new electrolyte medium are numerous. The polymeric configuration allows operating in a large field of temperature, even higher than room temperature, without, the risk of evaporation of the liquid component. The presence of lithium sulfides and/or polysulfides prevents the dissolution of the cathode, since it is present in saturated solution, and impedes further dissolution of ions. These are important advantages which allow the practical development of the Li—S battery, till now limited by instability of the cathode material and by reactivity of the conventional electrolyte medium.

Advantageously, the present invention provides the use of a cathode based on lithium sulfide, Li₂S, as to start from a battery in its discharge state (see process scheme). The cathode is made by a mixture of lithium sulfide and carbon, Li₂S—C, in different compositions. The mixture is prepared by means of low energy “ball milling”. The electrode is manufactured in the form of thin film by means of deposition with “die-casting” (hot pressing) technique of a mixture consisting of Li₂S—C and a binder polymer (e.g. preferably but not exclusively polyethylene oxide (PEO), polyvinyldene fluoride (PVdF), polyethylene glycol (PEG)) on a metal substrate, preferably but not exclusively aluminium. The so formed cathode will be subsequently indicated with the acronym Li₂S—C. The electrolyte medium is a membrane formed by hot pressing a mixture of polymer powders (e.g. preferably but not exclusively polyethylene oxide (PEO), polyvinyldene fluoride (PVdF), polyethylene glycol (PEG)), a lithium salt (e.g. preferably but not exclusively LiCF₆SO₃, LiPF₆, LiClO₄, LiBOB, LiTFSI) and a ceramic filler (e.g. preferably but not exclusively ZrO₂, SiO₂, Al₂O₃). The membrane is activated by adsorbing a solution of a lithium salt (e.g. preferably but not exclusively LiPF₆, LiClO₄, LiCF₆SO₃, LiBOB, LiTFSI) in an organic solvent (e.g. preferably but not exclusively EC-DMC, EC-DEC, EC-PC, EC-PC-DMC, EC-PC-DEC, EC-DEC-DMC), with different compositions, containing lithium sulfides and/or poly-sulfides (LiₓS_{y}) till saturation.

The anode can be a foil of lithium metal, and in this case the battery takes the schematic configuration Li/PSG/Li₂S—C. The battery is in the “discharge” form, therefore its activation requires start with a “charge” process: Li₂S 2Li+S, followed by the opposite “discharge” process: 2Li+S Li₂S, and so on for repeated charge and discharge cycles. Advantageously, this invention provides the use as electrolyte medium of the battery of a polymeric membrane instead of the common organic liquid solution. The membrane inhibits the lithium sulfide and/or the lithium polysulfides dissolution, increasing in this way the life cycles of the battery.

Moreover, this invention provides the use as anode materials of compounds based on metal alloys of lithium Li-M, with M preferably but not exclusively equal to Sn, Si, Sb, Mg, Al, and their combinations, trapped in a carbon matrix. Also in this case the battery is manufactured in the discharge form and its working requires the process of charge of activation: M-C+xLi₂S—>Li₂₋ₓM-C+xS followed by the discharge process: Li₂₋ₓM+xS—>M-C+xLi₂S and in this way by repeated charge and discharge cycles. Advantageously, this invention allows the use of anode materials with high specific capacity (for example 993 mAh/g for Li—Sn, 660 mAh/g for Li—Sb and 4,200 mAh/g for Li—Si) which, coupled with the sulfur cathode, can provide a lithium-ion polymer battery with schematic configuration M-C/PSG/Li₂S—C and with contents of specific energy much higher than those offered by common lithium-ion batteries. As a non exclusive example, the battery with M-C (Sn—C)/PSG/Li₂S—C, can cycle with capacity of the order of 1200 mAh/g considering the Li₂S active mass and with a voltage of the order of 2V, bringing to a specific energy of the order of 2,400 Wh/kg, which is about 4.3 times higher than the one offered by common lithium-ion batteries. Moreover, this invention advantageously allows the use of an anode different from lithium metal, in this way preventing the possibility of dendrite formations during charge and discharge processes with important advantages in terms of life and operating safety increase.

The use of the compounds M-C as anode materials has been reported in scientific publications (see G. Derrien, J. Hassoun, S. Panero, B. Scrosati, Adv. Mater., 19 (2007) 2336; J. Hassoun, G. Derrien, S. Panero, B. Scrosati, Adv. Mater. 20 (2008) 3169) and in an earlier patent (J. Hassoun, S. Panero, P. Reale, B. Scrosati Italian Patent application, RM2008A000381, Jul. 14, 2008), however in global battery configurations totally different from the one which this invention relates to.

There exists a large number of publications both scientific and patents on lithium-sulfur batteries, but it relates to systems completely different from the one disclosed in this invention, which is characterized by a series of original elements such as: 1) use of cathodic material based on lithium sulfide; 2) use of a polymeric electrolyte consisting of a gel based on a polymer (e.g. preferably but not exclusively polyethylene oxide (PEO), polyvinyldene fluoride (PVdF), polyethylene glycol (PEG)) and of a saturated solution of lithium sulfides and/or polysulfides (LiₓS_{y}); 3) use of a lithium-metal alloy anode M-C (where M is preferably but not exclusively Sn, Si, Sb, Mg, Al and their combinations); 4) combination of the above mentioned three materials to provide new configurations of polymeric lithium-sulfur battery; 5) combination of the above mentioned three materials to provide new configurations of polymeric lithium ion-sulfur battery.

Advantageously the use of a new electrolyte medium made by a membrane prepared by immobilizing a solution of a lithium salt (e.g. preferably but not exclusively LiPF₆, LiClO₄, LiCF₆SO₃, LiBOB, LiTFSI) in a organic solvent mixture (e.g. preferably but not exclusively EC-DMC, EC-DEC, EC-PC, EC-PC-DMC, EC-PC-DEC, EC-DEC-DMC) added with lithium sulfides (Li₂S) and/or polysulfides (LiₓS) till saturation, in a polymeric matrix (e.g. preferably but not exclusively polyethylene oxide (PEO), polyvinyldene fluoride (PVdF), polyethylene glycol (PEG)) containing a lithium salt (e.g. preferably but not exclusively LiCF₆SO₃, LiPF₆, LiClO₄, LiBOB, LiTFSI), allows operating in broad ranges of temperature without any risk of evaporation of the liquid component. The presence of the lithium sulfide prevents the dissolution of the polysulfides (LiₓS) assuring the operating stability. These technical solutions in manufacturing allow the practical development of a Li—S battery, which has been up to now limited by instability of the cathodic material and by reactivity of the conventional electrolyte medium.

Therefore, it is an object of this invention the preparation of an electrolytic membrane prepared by immobilizing a solution of a lithium salt (e.g. preferably but not exclusively LiPF₆, LiClO₄, LiCF₆SO₃, LiBOB, LiTFSI) in a organic solvent mixture (e.g. preferably but not exclusively EC-DMC, EC-DEC, EC-PC, EC-PC-DMC, EC-PC-DEC, EC-DEC-DMC) added with lithium sulfides (Li₂S) and/or polysulfides (LiₓS) till saturation, in a polymeric matrix (e.g. preferably but not exclusively polyethylene oxide (PEO), polyvinyldene fluoride (PVdF), polyethylene glycol (PEG)) containing a lithium salt (e.g. preferably but not exclusively LiCF₆SO₃, LiPF₆, LiClO₄, LiBOB, LiTFSI). The formation of the membrane takes place by means of die-casting of a mixture of powders of the polymer and the lithium salt. The membrane is activated by means of adsorption of a solution a lithium salt (e.g. preferably but not exclusively LiPF₆, LiClO₄, LiCF₆SO₃, LiBOB, LiTFSI) in a organic solvent mixture (e.g. preferably but not exclusively EC-DMC, EC-DEC, EC-PC, EC-PC-DMC, EC-PC-DEC, EC-DEC-DMC) containing lithium sulfides and/or poly-sulfides (LiₓS) till saturation.

Advantageously, this invention provides the use of a cathode based on lithium sulfide, Li₂S, for manufacturing the battery in a discharge state and with low reactivity and allowing the use of anode materials of the lithium-ion kind.

Therefore, it is an object of this invention the preparation of a cathodic material made by a mixture of lithium sulfide and carbon, Li₂S—C, in different compositions, preferably but not exclusively in a 1:1 ratio, prepared by means of low energy “ball milling”. The electrode is manufactured in the form of thin film by means of deposition with “die-casting” technique, on a metal substrate, preferably but not exclusively aluminium, from a mixture consisting of Li₂S—C and of a binder polymer, preferably but not exclusively polyethylene oxide (PEO), polyvinyldene fluoride (PVdF), polyethylene glycol (PEG) or a combinations thereof.

Advantageously, the present invention provides the use of an anode made by a foil of lithium metal. Therefore, it is object of this invention a polymeric lithium-sulfur battery, wherein the anode of lithium metal is combined with the cathode Li₂S—C and with an electrolytic polymeric membrane. The so formed battery is in the “discharge” form and its activation requires start with a “charge” process, followed by the opposite process of discharge, and in this way subsequently and repeated cycles of charge and discharge. The new electrolytic material, by preventing the formation of dendritic deposits, ensures many charge and discharge processes follow one after another.

Advantageously, this invention provides the use of anode materials with high specific capacity such as compounds based on metal alloys of lithium Li-M, with M preferably, but not exclusively, equal to Sn, Si, Sb, Mg, Al, and their combinations.

Therefore, it is an object of this invention a lithium-sulfur polymer battery, wherein the anode of Li-M metal alloy is combined with the Li₂S—C cathode and with an electrolytic membrane polymeric. Also in this case, the battery is manufactured in the discharge form and its working requires an activation charge process followed by the discharge process and in this way, by repeated charge and discharge cycles. Advantageously, this invention allows the use of an anode different from metal lithium, preventing in this way the possibility of dendritic formations during the charge and discharge processes with important advantages in terms of increase of life and operating safety.

The materials of lithium metal alloy have already been disclosed in other patent and different publications but in connection with a battery completely different than the one disclosed therein. A lithium sulfide based cathode has already been disclosed as such, but not in the configuration of the battery herein disclosed. The polymeric electrolyte finds its innovative feature in the addition of the saturated solution of lithium sulfide.

The lithium-sulfur polymer battery can be prepared according to the following way.

1. Preparation of the anode electrode.

The lithium metal anode is prepared by pressing the lithium on a copper mesh or foil.

The metal M-C alloy anode is prepared by means of “casting” on a copper foil or mesh a dispersion of active material (M-C), carbon additive (for example super P) and polymeric binder (for example PVdF) in a variable ratio in a low boiling solvent (for example NMP).

2. Preparation of the cathode material.

The positive electrode is prepared by means of die-casting on an aluminium foil or mesh a mixture of the active material Li₂S—C and polymeric binder (for example PEO) in variable ratio.

3. Preparation of the electrolytic membrane.

The formation of the membrane occurs by means of die-casting by immobilizing a solution of a lithium salt (e.g. preferably but not exclusively LiPF₆, LiClO₄, LiCF₆SO₃, LiBOB, LiTFSI) in a organic solvent mixture (e.g. preferably but not exclusively EC-DMC, EC-DEC, EC-PC, EC-PC-DMC, EC-PC-DEC, EC-DEC-DMC) added with lithium sulfides (Li₂S) and/or polysulfides (LiₓS) till saturation, in a polymeric matrix (e.g. preferably but not exclusively ppolyethylene oxide (PEO), polyvinyldene fluoride (PVdF), polyethylene glycol (PEG)) containing a lithium salt (e.g. preferably but not exclusively LiCF₆SO₃, LiPF₆, LiClO₄, LiBOB, LiTFSI).

For example, in test cells, the membrane is manufactured by die-casting of a mixture of powders of PEO and LiCF₃SO₃. The membrane is activated by means of adsorption of a solution of LiPF₆ EC:DMC, in different compositions, preferably but not exclusively 1:1, containing lithium sulfides and/or polysulfides (LiₓS_{y}) at saturation.

4. Preparation of the polymer battery.

The polymer battery object of this invention is assembled by facing the negative electrode film (anode) to the positive electrode film (cathode) and separating them by means of an electrolytic membrane. The present invention considers two different configurations for the kind of anode; one provides the use of a lithium metal anode (battery lithium-sulfur) and the other an Sn—C anode (battery lithium ion-sulfur). The method of manufacturing is the same for both versions. The electrolyte membrane can be activated “in situ”: the negative electrode/membrane PEO.LiCF₃SO₃/positive electrode assembly, after lodging in a thermo-sealable plastic polymer sheet, is activated by means of adsorption of the liquid component (EC:DMC, LiPF₆, LiₓS_{y} sat. solution). After the addition of electric contacts (copper for the negative electrode and aluminium for the positive electrode), the sheet is vacuum-sealed for preventing any contact with the atmosphere.

The invention is also illustrated by figures, both in the lithium-sulfur polymer battery and lithium ion-sulfur battery.

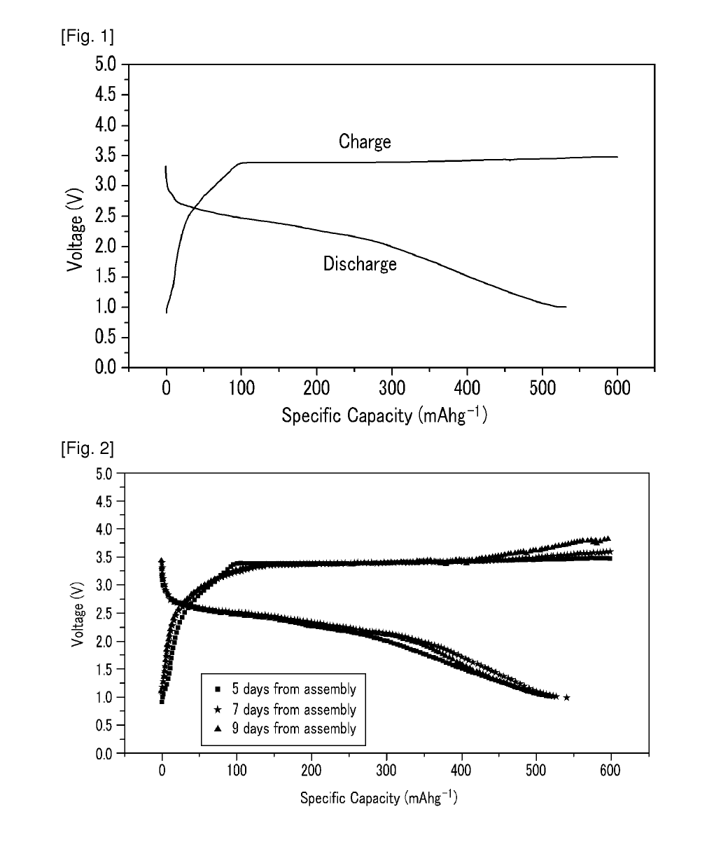

FIG. 1 shows a charge and discharge cycle run at t=60° C. and at a rate of C/20 (evolution of the capacity in mAh/g) for the lithium-sulfur polymer battery made by an anode of lithium metal, a cathode based on Li₂S—C and a polymeric electrolytic membrane of PEO-LiCF₃SO₃-EC:DMC, LiPF₆, LiₓS_{y} sat.

FIG. 2 shows repeated charge and discharge cycles run at t=60° C. and at a rate of C/20 (evolution of the capacity in mAh/g) and in subsequent times for the lithium-sulfur polymer battery made by a lithium metal anode, a cathode based on Li₂S—C and a PEO-LiCF₃SO₃-EC:DMC, LiPF₆, LiₓS_{y} sat. electrolytic polymeric membrane.

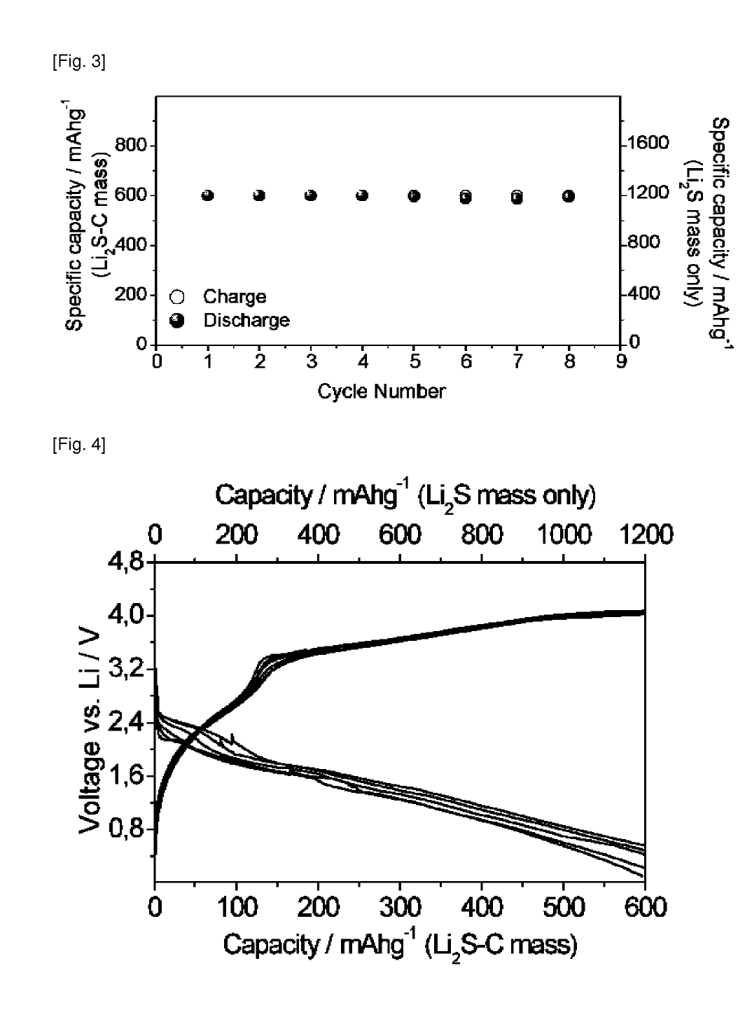

FIG. 3 shows the response in repeated charge and discharge cycles run at t=60° C. and at a rate of C/20 (evolution of the capacity in mAh/g) for the lithium-sulfur polymer battery made by a lithium metal anode, a cathode based on Li₂S—C and a PEO-LiCF₃SO₃-EC:DMC, LiPF₆, LiₓS_{y} sat. electrolytic polymeric membrane.

FIG. 4 shows the cycles of charge at a rate of C/5 and discharge at a rate of C/20 run at t=60° C. (evolution of the capacity in mAh/g) for the lithium ion-sulfur polymer battery made by an anode based on Sn—C, a cathode based on Li₂S—C and an electrolytic polymeric membrane PEO-LiCF₃SO₃-EC:DMC, LiPF₆, LiₓS_{y} sat.

While the present invention has been particularly shown and described with reference to exemplary embodiments thereof, it will be understood by those of ordinary skill in the art that various changes in form and details may be made therein without departing from the spirit or scope of the present invention as defined by the following claims.

1. A lithium-sulfur polymer battery comprising
a anode and
a cathode separated by an electrolyte
wherein the electrolyte is formed by a membrane containing a solution of a lithium salt in aprotic organic solvents with the addition of lithium sulfide and/or lithium polysulfides until saturation, this solution being trapped in a polymer matrix.

2. The lithium-sulfur polymer battery according to claim 1, wherein the electrolyte is a membrane formed by hot pressing a mixture of polymer powders and a lithium salt.

3. The lithium-sulfur polymer battery according to claim 1, wherein the polymer powders are selected from the group consisting of poly(ethylenoxide) (PEO), poly(acrylonitrile), polyacrylonitrile (PAN), poly(vinylidene fluoride) (PVdF) and a combination thereof.

4. The lithium-sulfur polymer battery according to claim 1, wherein the lithium salt is selected from the group consisting of LiCF₃SO₃, LiPF₆, LiClO₄, LiBF₄, LiB(C₂O₄), LiN(SO₂F)₂, LiN(SO₂CF₃)₂, LiN(SO₂C₂F₃)₂, and a combination thereof.

5. The lithium-sulfur polymer battery according to claim 1, wherein the solution is formed by a mixture of aprotic organic solvents, selected from the group consisting of ethylene carbonate (EC), propylene carbonate (PC), dimethylcarbonate (DMC), ethyl methyl carbonate (EMC), diethyl carbonate (DEC), and a combination thereof.

6. The lithium-sulfur polymer battery according to claim 1, wherein the anode is a lithium metal foil.

7. The lithium-sulfur polymer battery according to claim 1, wherein the cathode is based on lithium sulfide (Li₂S) and comprises a composite (Li₂S—C) of lithium sulfide and carbon.

8. The lithium-sulfur polymer battery according to claim 7, wherein the composite Li₂S—C is cast as a thin film on a substrate formed by aluminum.

9. The lithium-sulfur polymer battery according to claim 1, wherein the anode is a M-C composite where M is selected from the group consisting of Sn, Si, Sb, Mg, Al and a combinations thereof.

10. The lithium-sulfur polymer battery according to claim 9, wherein the M-C composite is cast as a thin film on a substrate formed by copper.

11. The lithium-sulfur polymer battery according to claim 2, wherein the polymer powders are selected from the group consisting of poly(ethylenoxide) (PEO), poly(acrylonitrile), polyacrylonitrile (PAN), poly(vinylidene fluoride) (PVdF) and a combination thereof.

12. The lithium-sulfur polymer battery according to claim 2, wherein the lithium salt is selected from the group consisting of LiCF₃SO₃, LiPF₆, LiClO₄, LiBF₄, LiB(C₂O₄), LiN(SO₂F)₂, LiN(SO₂CF₃)₂, LiN(SO₂C₂F₃)₂, and a combination thereof.

13. The lithium-sulfur polymer battery according to claim 2, wherein the solution is formed by a mixture of aprotic organic solvents, selected from the group consisting of ethylene carbonate (EC), propylene carbonate (PC), dimethylcarbonate (DMC), ethyl methyl carbonate (EMC), diethyl carbonate (DEC), and a combination thereof.

14. The lithium-sulfur polymer battery according to claim 2, wherein the anode is a lithium metal foil.

15. The lithium-sulfur polymer battery according to claim 2, wherein the cathode is based on lithium sulfide (Li₂S) and comprises a composite (Li₂S—C) of lithium sulfide and carbon.

16. The lithium-sulfur polymer battery according to claim 2, wherein the anode is a M-C composite where M is selected from the group consisting of Sn, Si, Sb, Mg, Al and a combinations thereof.
